(19) United States
(12) Patent Application Publication
(10) Pub. No.: US 2012/0247236 A1
(43) Pub. Date: Oct. 4, 2012

(54) SENSOR WITH AGING FUNCTION

(75) Inventors: Hisayoshi ISHIBASHI, Tokyo (JP); Hirokazu SUZUKI, Tokyo (JP); Akihiko NISHIMURA, Kyoto (JP); Yukihiro SHIMADA, Fukui (JP)

(73) Assignees: JAPAN ATOMIC ENERGY AGENCY, Ibaraki (JP); KUMAGAI GUMI CO., LTD., Fukui (JP)

(21) Appl. No.: 13/315,594

(22) Filed: Dec. 9, 2011

(30) Foreign Application Priority Data
Mar. 31, 2011 (JP) 2011-078468

(51) Int. Cl. G01D 21/00

(52) U.S. Cl. 73/866.5

(57) ABSTRACT

A sensor with aging function is provided wherein installation space for an apparatus to perform an aging process and the number of apparatuses can be reduced which enables easy and reliable aging processes and can improve measuring accuracy and enhance measuring reliability of the sensor. The sensor with aging function 10 is attached, through a bonding agent 15, to a high temperature measuring object 14, comprising a block body 12 constructed by integrally forming a sensor main body 11 and an electric heater 13 disposed in a manner to be close to the sensor main body 11 using a molding process, wherein a bonding surface on which the bonding agent 15 is applied is formed on the measuring object 14 side of the block body 12.

### BACKGROUND OF THE INVENTION

1. Field of the Invention

The present invention relates to a sensor for measuring a temperature, distortion, and the like of a measuring object and particularly to the sensor with aging function to be attached, through a bonding agent, to a high temperature measuring object.

2. Description of the Related Art

Conventionally, a sensor is used to measure a temperature, distortion, vibration, and the like of a high temperature measuring object such as pipes, for example, in a nuclear power plant (see, for example, Patent Reference 1 “Japanese Patent Application Laid-open No. 2001-296110” or Patent Reference 2 “Japanese Patent Application Publication No. 2008-534982”).

Generally, the conventional sensor of this type is attached to the high temperature measuring object by using a ceramic-based bonding agent and an aging process (preliminary operation for stabilization) at a predetermined high temperature for a predetermined time is required. The aging process is to be performed ordinarily by raising the temperature of the bonding agent using an electric furnace.

However, the conventional sensor has problems. That is, if the measuring object is large or long, it is impossible to perform the aging process in the electric furnace. To solve this problem, the possibility of performing the aging process locally on the bonding agent by using a temperature raising box partially designed in imitation of the electric furnace was expected, however, if there are many places requiring the aging process, wide space for the installation of the temperature raising box is necessary and/or the number of the temperature raising boxes increases and, after all, it proved to be impossible to use the temperature raising box.

### SUMMARY OF THE INVENTION

In view of the foregoing, it is an object of the present invention to provide a sensor with aging function which can reduce the installation space for a aging process, decrease the number of the installations of an apparatus for the aging process, perform easy and reliable aging process, improve the measuring accuracy, and enhance measuring reliability.

According to a first aspect of the present invention, there is provided a sensor with aging function to be attached, through a bonding agent, to a high temperature measuring object, including a block body constructed by integrally forming a sensor main body and an electric heater disposed in a manner to be close to the sensor main body using a molding process, wherein a bonding surface on which the bonding agent is applied is formed on the measuring object side of the block body.

According to a second aspect of the present invention, there is provided the sensor with aging function wherein the electric heater is disposed outside the sensor main body.

According to a third aspect of the present invention, there is provided the sensor with aging function wherein the sensor main body has a woven fabric formed by weaving a warp and weft in a manner in which the warp and weft intersect approximately at right angles and an optical fiber is contained in at least either of the warp or weft forming the woven fabric.

By configuring as above, various effects can be obtained which include the reduction in the installation space of an apparatus for the aging process and the decrease in the number of installations of apparatuses, easy and reliable aging process, improvement of measuring accuracy, and enhancement of reliability.

### BRIEF DESCRIPTION OF THE DRAWINGS

FIG. 1 is a perspective view showing a sensor with aging function of the embodiment of the present invention.

FIG. 2 is a cross-sectional view showing the sensor with aging function of the embodiment of the present invention.

FIG. 3 is a plan view showing a sensor main body to be used for the sensor with aging function of the embodiment of the present invention.

### DESCRIPTION OF THE PREFERRED EMBODIMENTS

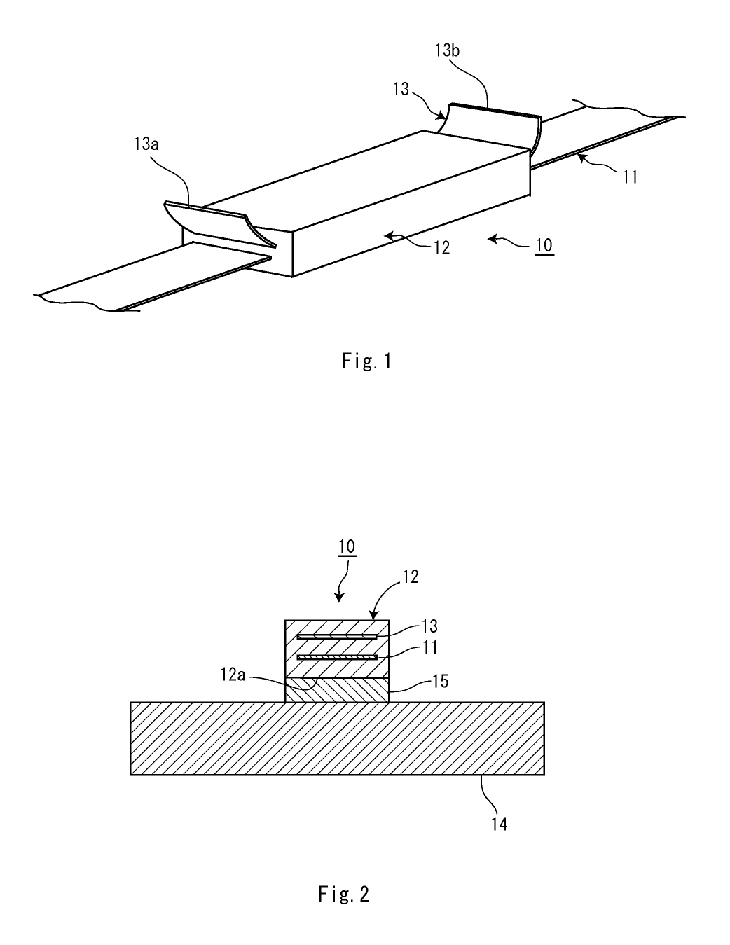

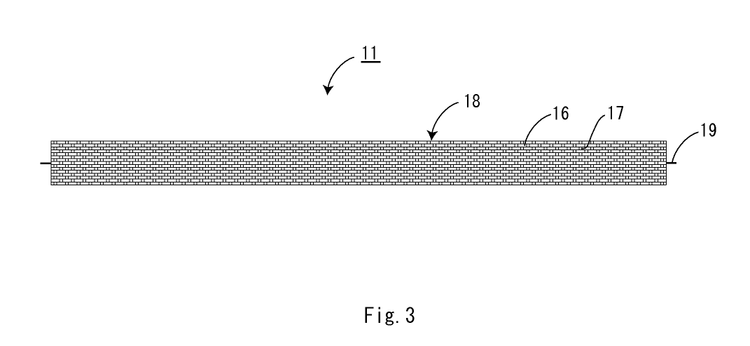

Hereinafter, a sensor with aging function of the embodiment of the present invention is described by referring to drawings. FIG. 1 is a perspective view showing the sensor with aging function of the embodiment of the present invention. FIG. 2 is a cross-sectional view showing the sensor with aging function of the embodiment of the present invention. FIG. 3 is a plan view showing a sensor main body to be used for the sensor with aging function of the embodiment of the present invention.

The sensor with aging function 10 of the embodiment of the present invention has a band-shaped sensor main body 11, a block body 12 disposed in a predetermined position of the sensor main body 11, and a thin-plate like electric heater 13 disposed approximately in parallel to the sensor main body 11 inside each block body 12, wherein the sensor with aging function 10 can be attached, through the block body 12, to high temperature measuring objects such as special stainless steel pipes, equipment, or the like, which have temperatures reading as high as the maximum at about 650 of a fast reactor in a nuclear power plant.

The sensor main body 11, as shown well in FIG. 3, has a woven fabric 18 formed by weaving a warp 16 and weft 17 in a manner in which the warp 16 and weft 17 intersect approximately at right angles. The warp 16 of the woven fabric 18 forms fiber bundles one piece of which includes one piece of an optical fiber 19 and is formed of, for example, one piece of the optical fiber 19 and ninety-nine pieces of glass fibers. Moreover, as a material for the warp 16 or weft 17, for example, a carbon fiber, aramid fiber, glass fiber, alumina fiber, and synthetic fiber such as nylon, vinylon, or polyester can be used, however, it is preferable that, in order to protect the optical fiber 19, a high-strength fiber having tensile strength being higher than that of the optical fiber 19 is employed. Also, the optical fiber 19 may be contained not only in the warp 16 but also in the weft 17; that is, all that is required is that the optical fiber 19 is contained in at least either of the warp 16 or weft 17. Further, it is possible that the material for the warp 16 and weft 17 is changed in such a case where the glass fiber is used as the warp 16 and the carbon fiber as the weft 17 or it is possible that fibers of different types are combined in such a case where, as the material for the warp 16 and weft 17, a plurality of types of fibers are used in a combined manner.

The optical fiber 19, according to the embodiment of the present invention, functions as an FBG (Fiber Bragg Grating)sensor. The FBG sensor is a known sensor comprising a plurality of detecting sections (not shown) configured by applying ultraviolet rays to cores of the optional fibers 19, which is designed to measure distortion, pressure, temperature, and the like of the measuring object 14 by observing a change in a wavelength of light reflecting in these detecting sections.

Moreover, the sensor body 11 is preferably provided with a symbol (not shown) to identify a position for installing the block body 12 and also a position of the detecting section by giving color thereto or printing a mark or the like thereon, thus enabling the installation of the block body 12 at the attaching position of the measuring object 14 and enabling the block body 12 and detecting sections to be reliably positioned at the measuring position where temperatures or the like of the measuring object 14 are measured by the detecting sections, thereby making it possible to further improve measuring accuracy of the sensor 10.

The block body 12 is constructed so as to be flat and rectangular solid-shaped by integrally forming the sensor main body 11 and electric heater 13 using a molding process. On the side of the measuring object 14 of the block body 12, a bonding surface 12a is formed in a manner to conform to a surface shape of the high temperature measuring surface 14 to which the sensor 10 is bonded and, by applying a ceramic-based bonding agent 15 for high temperature measurement use to the bonding surface 12a, the sensor 10 is fixed to the high temperature measuring object 14.

The electric heater 13 is formed so as to be thin-plate shaped by using known technologies by which a metal heating element is printed on a surface of a metal plate such as high-density alumina or a heat-generating paint such as carbon-based paint or the like is applied to a surface of a high polymer film or a nichrome wire is put between insulating plates or a line-like heat element is fitted into a groove formed on the surface of the metal plate. Moreover, the electric heater 13 is preferably disposed outside the sensor main body 11 (on the opposite side of the measuring object 14), whereby the occurrence of cracking in the block body 12 between the sensor main body 11 and measuring object 14 can be reliably prevented or separation of the block body 12 can be also reliably prevented, thus enabling the improvement of measuring accuracy of the sensor 10.

Further, both end portions 13a and 13b of the electric heater 13 extend to the outside from both ends of the block body 12 and the electric heater 13 is connected, through a lead line connected to the both end portions 13a and 13b, to power sources (not shown). In addition, a plurality of power sources for the electric heaters is preferably put together into one, which enables installation space for an apparatus to be reduced and/or the number of installations to be decreased.

When a temperature, distortion, vibration, and the like of the high temperature measuring object 14 are to be measured by using the sensor with aging function as described above, first, the bonding agent 15 is applied to the bonding surface 12a of the block body 12 and the sensor 10 is fixed to the measuring object 14. Then, a current is passed through the electric heater 13 and, after an aging process (preliminary operation for stabilization)is performed at a predetermined high temperature (for example, 100 to 200) and for a predetermined time (for example, 1 to 24 hours), designated measurements of the high temperature measuring object are made by the sensor 10.

According to the sensor with aging function 10 as described above, even when the measuring object 14 is long or large, owing to the improvement of the measuring accuracy of the sensor 10 and enhanced measuring reliability, the easy and reliable aging process is allowed to be performed. Moreover, in the case of the sensor with aging function as described above, no wide space for the installation of the apparatus for the aging process is required and no number of the installations of the apparatuses are increased and, therefore, the applications of the sensor 10 can be expanded and its general versatility can be enhanced.

Also, according to the sensor with aging function, since the sensor main body 11 can be easily and surely attached to the measuring object 14 by simple attachment of the block body 12 and the bonding surface 12a is formed on the side of the measuring object 14 of the block body 12 in a manner to conform to the surface shape of the high temperature measuring object 14, simplification of the operation of attaching the sensor to the measuring object 14 can be realized and distortion and temperatures of the measuring object 14 are reliably propagated to the sensor portion of the optical fiber, thus enabling further improvement of measuring accuracy of the sensor 10.

Further, the optical fiber 19 of the sensor main body 11 is protected by the fiber bundle described above, which prevents the optical fiber 19 from being broken or cut when the sensor 10 is attached to the measuring object 14, as a result, enabling the improvement of durability of the sensor 10.

Still further, the sensor 10 can be conveyed in a state of being wound up and, therefore, operations of its conveyance can be made simplified and also can be extended by fusion-connecting end portions of the optical fiber 19 to one another and can be attached easily to the measuring object 14 in a manner to conform to its size, shape, and the like of the measuring object 14.

In the above embodiment of the present invention, it is not necessary to say that the example in which the optical fiber 19 functions as the FBG sensor is explained, however, one functional example of the sensor body 11 is merely described; that is, the sensor main body 11 can be applied not only to a microbend-type sensor by which distortion of a measuring object is measured by detecting a change in amounts of transmittance of light, to a rayleigh scattering-type sensor by which distortion of a measuring object is measured by detecting a change in amounts of reflection of light, and to a case where the optical fiber 19 functions as a sensor other than the FBG sensor such as a sensor which measures vibration, temperature, pressure, ultrasounds, neutral beams, gamma rays or the like, but also to a sensor having no optical fiber 19.

Examples of various features/aspects/components/operations have been provided to facilitate understanding of the disclosed embodiments of the present invention. In addition, various preferences have been discussed to facilitate understanding of the disclosed embodiment(s) of the present invention. It is to be understood that all examples and preferences disclosed herein are intended to be non-limiting.

Although selected embodiment(s) of the present invention have been shown and described, it is to be understood the present invention is not limited to the described embodiment(s). Instead, it is to be appreciated that changes may be made without departing from the principles and spirit of the invention, the scope of which is defined by the claims and the equivalents thereof.

What is claimed is:

1. A sensor with aging function to be attached, through a bonding agent, to a high temperature measuring object, comprising:
a block body constructed by integrally forming a sensor main body and an electric heater disposed in a manner to be close to the sensor main body using a molding process;
wherein a bonding surface on which the bonding agent is applied is formed on the measuring object side of the block body.

2. The sensor with aging function according to claim 1, wherein the electric heater is disposed outside the sensor main body.

3. The sensor with aging function according to claim 1, wherein the sensor main body has a woven fabric formed by weaving a warp and weft in a manner in which the warp and weft intersect approximately at right angles and an optical fiber is contained in at least either of the warp or weft forming the fabric.

4. The sensor with aging function according to claim 2, wherein the sensor main body has a woven fabric formed by weaving a warp and weft in a manner in which the warp and weft intersect approximately at right angles and an optical fiber is contained in at least either of the warp or weft forming the fabric.
